(19) United States
(12) Patent Application Publication
(10) Pub. No.: US 2006/0092275 A1
(43) Pub. Date: May 4, 2006

(54) Timing, photographing system

(76) Inventor: Clair Donald Cole, Port Sanilac, MI (US)

Correspondence Address: Christopher John Rudy, Ste. 8, 209 Huron Ave., Port Huron, MI, 48060, US

(21) Appl. No.: 11/256,814

(22) Filed: Oct. 24, 2005

Related U.S. Application Data
(60) Provisional application No. 60/622,250, filed on Oct. 26, 2004.
(60) Provisional application No. 60/642,912, filed on Jan. 11, 2005.

(51) Int. Cl. H04N 7/18; H04N 9/47

(52) U.S. Cl. 348/61

(57) ABSTRACT

Device can note or memorialize a date and/or time, and includes a housing; a dating/timing contrivance mounted in conjunction with the housing; and a control contrivance that communicates a controlling event to the dating/timing contrivance so that noting or memorializing the date and/or time at which the controlling event takes place can be effected. The device can be configured with a camera, and/or further include, in combination, a special object, for example, a wine bottle. Method in noting or memorializing an event can include providing the device; and activating its dating/timing and/or photographing contrivance(s).

This claims benefits under 35 USC 119(e) of U.S. provisional patent application Nos. 60/622,250 filed on Oct. 26, 2004 A.D., and 60/642,912 filed on Jan. 11, 2005 A.D. The specifications of both of those applications are incorporated herein by reference in their entireties.

### FIELD OF THE INVENTION

The present invention concerns a device and method for noting or memorializing a date and/or time. It is particularly notable when used with an object for which memorializing is of special significance, for example, a home sale closing at which a bottle of wine is opened. The device may be configured with a camera.

### BACKGROUND TO THE INVENTION

Sometimes persons engage in celebrations or pass milestones in their lives, and at many of such times a special object comes into play. For example, at a wedding or anniversary, a certain bottled wine may be provided for enjoyment.

At other times breaking or tampering with a seal to a vessel can be critical to later performance of an enclosed product.

It would be desirable to address such instances, and others.

### DISCLOSURE OF THE INVENTION

The invention provides a device for noting or memorializing a date and/or time, which comprises a housing; a dating/timing contrivance mounted in conjunction with the housing; and a control contrivance that communicates a controlling event to the dating/timing contrivance so that noting or memorializing the date and/or time at which the controlling event takes place can be effected. The device can be configured with a camera, and/or further comprise, in combination therewith, a special object. In another aspect, a method in noting or memorializing an event comprises providing said device; and activating its dating/timing and/or photographing contrivance(s).

The invention is useful in memorializing event(s).

Significantly, by the invention, celebrations or milestones in people's lives, particularly those in which a special object comes into play can be noted or memorialized. For example, at a wedding, anniversary, or closing on the sale of a home, the time at which a certain bottled wine that may have been provided years earlier as part of a dowry was opened may be automatically noted or memorialized. Moreover, when configured with a camera, photos memorializing the event can be taken for posterity. As well, the tampering or breaking of a seal to a vessel holding contents that are sensitive to opening and exposure to outside elements can be noted or memorialized as to the time of such occurrence, and the contents disposed of or used within a safe time of the opening.

Numerous further advantages attend the invention.

The drawings form part of the specification hereof. With respect to the drawings, which are not necessarily drawn to scale, the following is briefly noted:

FIG. 1 is a front view of an embodiment of a device for noting or memorializing a date and/or time of the invention.

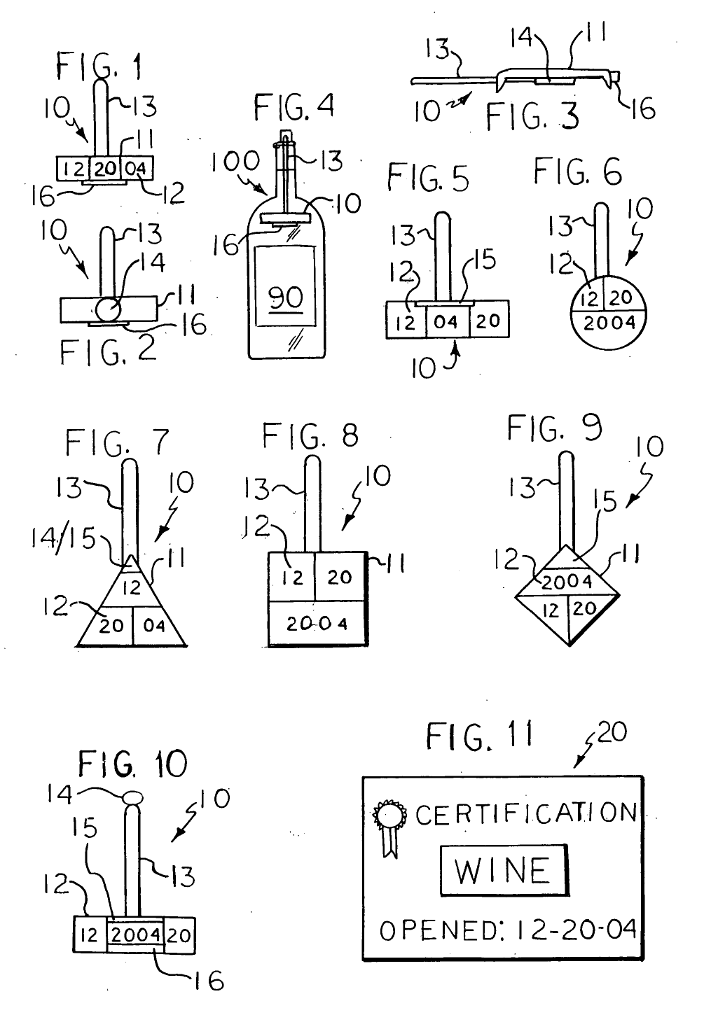

FIG. 2 is a side view of the device of FIG. 1.

FIG. 3 is a rear view of the device of FIG. 1.

FIG. 4 is a front view of the device of FIG. 1, in combination with a special object.

FIGS. 5-10 are front views of other embodiments of a device for noting or memorializing a date and/or time of the invention.

FIG. 11 is a certification memorial that can be employed in a method in noting or memorializing a date and/or time in the practice of the invention.

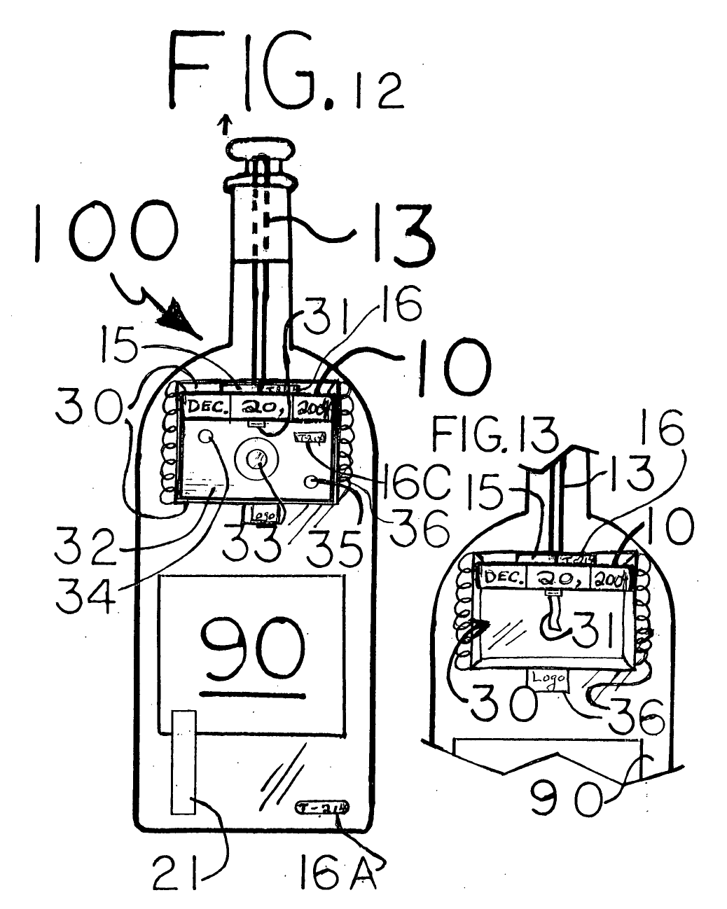

FIG. 12 is a front view of a device such as of FIGS. 1-3 or 5-10, configured with a camera, and provided in combination with a special object.

FIG. 13 is a front view of the device and special object of FIG. 12, which has the camera removed.

The invention can be further understood by the detail set out below, which may be read in view of the drawings. The same is to be taken in an illustrative and not necessarily limiting sense.

The present device can note or memorialize an event such as by date and/or time, and includes a housing; a dating/timing contrivance mounted in conjunction with the housing; and a control contrivance that communicates a controlling event to the dating/timing contrivance so that noting or memorializing the date and/or time at which the controlling event takes place can be effected. The device can be configured with a camera. The device with or without the camera may be employed in conjunction, if not in combination, with a special object, or the camera may be employed with a special object. Thus, the device or camera can be an augmentation or attachment to or be made integral with the special object. Beneficially, the device and/or camera is/are small; the dating/timing contrivance of the device is electronic; and the camera may employ traditional film or be electronic. Advantageously, the controlling event communicated to the device is a common or reasonably expected event, for example, the opening a cork on a bottle of wine, or breaking a seal on another vessel. Typically at that time the activated dating/timing device records the event, for example, by arresting its chronological activity. The camera, too, may be similarly controlled, but can be manually controlled to great benefit.

With respect to the drawings, device 10 includes housing 11, for example, of small size and made of injection molded plastic, and dating/timing contrivance 12, for example, an electronic clock with a digital display of a date, which is mounted in the housing 11. The dating/timing contrivance 12 can be activated to run at any convenient time, but preferably is activated to run in a controlled environment, say, at a factory where initializing of its dating/timing function is commenced and may be recorded. Control contrivance 13, for example, a loop of fine wire that completes a controlling circuit of the dating/timing contrivance 12, is joined to the contrivance 12. The contrivance 12 can be powered by battery 14 and/or solar or other ambient light power chip 15. When the control contrivance 13 is suitably disturbed by a controlling event, for example, breaking of a wire that serves as the control contrivance 13, the dating/timing contrivance 12 has its date and/or time function stop, with or without external display with the device 10 remaining afterward. Identification indicia 16 such as a serial number or other identification can be provided on the housing 11 as well. Auxiliary identification indicia 16A, which may relate to the indicia 16, may be provided, for example, on special object 90. Camera indicia 16C, which may relate to the indicia 16 and/or the indicia 16A, may also be provided on camera 32.

The device 10 can provide a convenient calendar.

Certification memorial or item 20, for example, a disc or card of gold or silver, or of fine paper suitable for display, may be provided to certify that the device 10 has been engaged. In particular, the item 20 can be provided to acknowledge that the device 10 has had its dating/timing contrivance 12 stop with the passing of a controlling event in relation to the device 10. Booklet 21 may be provided, for instance, to provide instructions for obtaining certification, for example, by attaching it to the special object 90.

Mounting recess 30 in the special object 90 may be provided, which may be enhanced with fastening aid 31, for example, a spring clip. The recess 30, for example, may be ¼-inch to ½-inch deep, and hold camera 32, say, with the assistance of the spring clip, or other means such as glue, and so forth and the like. Although a generally rectangular box type mounting recess 30 is depicted, the mounting recess 30 can be of any suitable shape, to include, as may be appropriate, triangular or pentangular, circular, elliptical or ovoid, and so forth. The camera 32, which, for instance, may take from one to twelve or twenty-four or more pictures, say, still pictures, or may be a movie camera, say, a digital type, has lens 33, which may be auto-focus or be designed to focus for subjects about from one to six feet or so away, and may have flash adaptation 34 and/or shutter control button 35 to take photographs manually. Recess border decoration 36, which may include artwork and/or a logo, may highlight and dress up space by the recess 30.

The device 10 and/or camera 32 can be mounted on or preferably in the recess 30 of special object 90, for example, bottle of wine, to form combination 100, say, with a wire serving as the control contrivance 13 that runs under an upper label and to a cork of the bottle 90. Mounting of the device 10 to the object 90 can be carried out by permitting the device 10 to hang by wire serving as the contrivance 13 outside or even inside a hollow object 90 and/or by securing the housing 11, for example, by applying a light duty adhesive on the back of the housing 11, by taping the housing 11 to the object 90, say, with decorative tape, by providing a receptacle in or on the object 90 into which the housing 11 is inserted, and so forth. As alluded to above, as an example, when the cork in the bottle 90 is pulled, the wire 13 breaks, and the date and/or time function of contrivance 12 stops. The wire 13 may also control the taking of a picture with the camera 32 in lieu of or in addition to any manual control such as by use of the shutter control button 35.

The device 10 that has its dating/timing contrivance arrested through a controlling event, especially one having the indicia 16 therewith, can be sent to a central location where the date and/or time of the dating/timing contrivance 12 is noted on a central register and/or the certification item 20 is prepared and typically returned to the submitter of the arrested device 10. Accordingly, preferably the indicia 16 identifies that the device 10 has been registered as associated with the particular special object 90, which may, again, have auxiliary indicia 16A, and which, with the device 10, forms the combination 100.

As well, a photograph or group of multiple photographs taken with the camera 32, while in the recess 30, or removed therefrom, may have its exposed film or activated electronic chip sent to the central location for development or printing. The indicia 16C may help in identifying pictures associated with the device 10. The certification item 20 can reflect this, for example, by listing such pictures and/or being provided to accompany or being provided in the form of a portfolio.

A single device 10 can have multiple dating/timing contrivances 12, each of which may be associated with a particular controlling event, be they the same or different, or series of controlling events, for example, the date(s) and/or time(s) which a closure was opened, say, on a bottle of liquor, beer or wine as the special object 90. A single special object 90 can have multiple devices 10 and/or cameras 32 mounted therewith. Such combinations 100 are also within the practice of this invention.

Accordingly, in general, the device 10 can be put on or in any and all types of bottles serving as the object 90, to include wine, whiskey, cognac, champagne, beer, and many others that may be used as a collector bottle or for a special occasion such as a wedding, anniversary, birthday, graduation, childbirth, sale of a home, and so forth. Such a bottle 90 can be time-dated, and when it “stops,” as by tampering or opening, the owner can note this and seek, if desired, registration, say, with certification by the item 20. Thus, the worth of a collectible may be ascertained with respect to the opening of its contents or opening of a case serving as the object 90 about the collectible, which has the device 10, or special occasion noted, and in such cases the same may be registered and acknowledged, say, with gold card 20, which can have data pertinent to the object 90 and date and/or time of its tampering or opening. With the object 90 a collectible, the longer the device 10 remains active and “counting,” the higher may be the value of the collectible 90. With the tampering or opening of the combination 100 of the device 10 and collectible 90, the date and/or time is “stopped,” and a certainty is introduced into the date on or time at which the collectible 90 is revealed, opened, or compromised. In conjunction therewith or separate from the device 10, valuable photographic evidence of the event can be provided by the camera 32.

The present invention is thus provided. Various features, parts, steps, subcombinations and combinations can be employed with or without reference to other features, parts, steps, subcombinations or combinations in the practice of the invention, and numerous adaptations and modifications can be effected within its spirit, the literal claim scope of which is particularly pointed out as follows:

What is claimed is:

1. In combination:
(A) a bottle and a camera; or
(B) a device for noting or memorializing a date and/or time, which comprises a housing; a dating/timing contrivance mounted in conjunction with the housing; and a control contrivance that communicates a controlling event to the dating/timing contrivance so that noting or memorializing the date and/or time at which the controlling event takes place can be effected; and which further comprises a camera associatable therewith; and
a special object.

2. The combination of claim 1, wherein the camera can take at least one of still pictures and moving pictures.

3. The combination of claim 2, wherein the camera can take both still and moving pictures.

4. The combination of claim 1, which is embodiment (B) wherein the dating/timing contrivance can act as a calendar.

5. The combination of claim 1, wherein the bottle of embodiment (A) and the special object of embodiment (B) in each case is a bottle for wine, whiskey, cognac, champagne, beer, and many others that may be used as a collector bottle or for a special occasion such as a wedding, anniversary, birthday, graduation, childbirth, sale of a home, and so forth.

6. The combination of claim 5, wherein:
the dating/timing contrivance is an electronic clock with a digital display of a date, which is mounted in the housing; the control contrivance is a loop of fine wire that completes a controlling circuit of the dating/timing contrivance; the controlling event is breaking of the wire that serves as the control contrivance so that the dating/timing contrivance has its date function stop; identification indicia is provided on the housing; the camera is controlled by at least one of the loop of fine wire and a manual shutter control button; and camera indicia is provided on the camera; and
the bottle is provided with auxiliary identification indicia, and a mounting recess, which is enhanced with a fastening aid, and in which recess the camera can be mounted.

7. The combination of claim 1, wherein the bottle of embodiment (A) and the special object of embodiment (B) in each case is a wine bottle.

8. A method in noting or memorializing a date and/or time, which comprises:
providing a device for noting or memorializing a date and/or time, which includes a housing; a dating/timing contrivance mounted in conjunction with the housing; and a control contrivance that communicates a controlling event to the dating/timing contrivance so that noting or memorializing the date and/or time at which the controlling event takes place can be effected, said device associatable with a special object; and
activating its dating/timing contrivance.

9. The method of claim 8, further comprising arresting the dating/timing contrivance through the control contrivance.

10. The method of claim 9, further comprising certifying date(s) and/or time(s) of the arresting.

11. The method of claim 10, wherein the dating/timing contrivance has acted solely as a calendar.

12. The method of claim 8, further comprising providing a camera for taking pictures, which is at least initially mounted on or in the special object.

13. The method of claim 11, further comprising taking pictures with the camera.

14. The method of claim 9, further comprising providing a camera for taking pictures, which is at least initially mounted on or in the special object, and taking pictures with the camera.

15. The method of claim 14, wherein the pictures are still.

16. The method of claim 14, wherein the pictures are moving.

17. The method of claim 14, further comprising certifying date(s) and/or time(s) of the arresting.

18. In combination:
a device for noting or memorializing a date and/or time, which comprises a housing; a dating/timing contrivance mounted in conjunction with the housing; and a control contrivance that communicates a controlling event to the dating/timing contrivance so that noting or memorializing the date and/or time at which the controlling event takes place can be effected; and
a special object, which is a bottle for wine, whiskey, cognac, champagne, beer, and many others that may be used as a collector bottle or for a special occasion such as a wedding, anniversary, birthday, graduation, childbirth, sale of a home, and so forth.

19. The combination of claim 18, wherein:
the dating/timing contrivance is an electronic clock with a digital display of a date, which is mounted in the housing; the control contrivance is a loop of fine wire that completes a controlling circuit of the dating/timing contrivance; the controlling event is breaking of the wire that serves as the control contrivance so that the dating/timing contrivance has its date function stop; and identification indicia is provided on the housing; and
the bottle is provided with auxiliary identification indicia.

20. The combination of claim 18, wherein the special object is a wine bottle.
